(19) United States
(12) Patent Application Publication
(10) Pub. No.: US 2010/0213193 A1
(43) Pub. Date: Aug. 26, 2010

(54) PACKAGING MATERIAL

(75) Inventors: Jurgen Helmlinger, Barnau (DE); Andreas Fischer, Kohlberg (DE)

Correspondence Address: YOUNG & THOMPSON, 209 Madison Street, Suite 500, Alexandria, VA, 22314, US

(73) Assignee: CONSTANTIA HUECK FOLIEN GMBH & CO. KG, Pirk (DE)

(21) Appl. No.: 12/601,455

(22) PCT Filed: May 21, 2008
(86) PCT No.: PCT/EP2008/004051

§ 371 Date: Apr. 22, 2010

(30) Foreign Application Priority Data
May 24, 2007 (EP) 07010312.2

(51) Int. Cl. B65D 51/00; B32B 15/08; B32B 5/00; B32B 7/12; B32B 3/00

(52) U.S. Cl. 220/200; 428/457; 428/458; 428/461; 428/339; 428/347; 428/201; 428/172

(57) ABSTRACT

The invention relates to a composite for packaging material with a symmetrical structure that consists of plastic/aluminum/plastic. The invention also relates to a container covering with a symmetrical composite structure that consists of polyester/aluminum/polyester, whereby polyethylene terephthalate (PET) is advantageously used as polyester.

The invention relates to a packaging material, particularly suitable for container coverings.

Container coverings that are used for packaging foods, such as milk products, for example yogurt, cheese, cottage cheese, juices, pastries, peanuts, dips, prepared sauces, etc., have to be designed to be food-safe on the side that faces the product (compliance with the provisions of the food laws).

From WO 98/26931, packaging elements are known that have a coating with a rough surface on a carrier material on the side that faces the package contents, whereby plastic or aluminum or two-layer composites that consist of aluminum/aluminum, aluminum/plastic, plastic/aluminum, aluminum/paper or the like are used as carrier materials.

From WO 01/74685, a cover element for closing containers, which consists of a uniform metal foil or a plastic film, is known.

From WO 99/29508, partially embossed cover elements for food containers that consist of a foil material, which can consist of, i.a., the following three-layer composite combinations: aluminum/paper/plastic, aluminum/paper/aluminum, or aluminum/plastic/aluminum, are known.

Aluminum is not, however, resistant to all package contents, for example yogurt, processed cheese, milk products, juices, pastries, peanuts, dips, prepared sauces, etc.

Therefore, these three-layer composites have to be provided on the side that faces the package contents, in any case with a full-surface food-safe (compliance with the provisions of the food laws) coating.

Furthermore, especially during shipping of the packaging, which is closed with aluminum coverings, the danger of so-called “flex cracks” exists, which are essentially produced by the movement of the package contents. In this case, creases occur in the aluminum layer of the container covering. Subsequently, these creases result in leakage; the packaging material can exit or it spoils.

The object of this invention is to prepare a composite for packaging material, in particular container coverings, which has an improved puncture resistance and tearing resistance, as well as excellent resistance to package contents.

The subject of the invention is therefore a composite for packaging material, in particular for container coverings, characterized in that the composite consists of a symmetrical plastic/aluminum/plastic composite.

The composite can also have a heat-seal coating on the side that faces the product.

A film that consists of polypropylene, polyethylene, polyamide, and especially preferably polyester, is preferably used as a plastic in the composite according to the invention.

Aluminum foil is laminated between two plastic films with use of a laminating adhesive.

Known laminating adhesives based on polyurethane are preferably used.

The thickness of the plastic films can be 3-100 μm in each case, preferably 10-30 μm.

The thickness of the aluminum layer enclosed between the plastic films can be about 3-40 μm, preferably 6-15 μm.

By situating the aluminum foil in a symmetrical composite between two plastic films, numerous advantages are created:

The composite is absolutely corrosion-resistant and food-safe (compliance with the provisions of the food laws). Also, the composite has an improved puncture resistance and tearing resistance compared to comparable composites or structures with aluminum foil on the outsides thereof.

Flex-crack damage is precluded; this is prevented by the plastic films on the outside of the composite.

Also, the aluminum foil can be printed, whereby printing inks can be used both on the outside and on the inside, since the printed surface is covered by the plastic film, and the printing ink cannot come into contact with the package contents.

When glazing printing inks are used in the printing of the aluminum foil, additional matt/glossy effects can be achieved.

Also, the composite can be produced economically, since relative to the known composites, a smaller amount of expensive aluminum foil (only one foil instead of, previously, two foils as outer foils of a composite) is necessary.

The composite can be unembossed or at least partially embossed to ensure the individuality of the pre-cut foil patterns, for example in the form of container coverings. Optionally, on the surface thereof, spacers can also be applied. Such spacers are known from, for example, WO 01/68475 in the form of expanding partial coatings. Other partial coatings applied by printing can also be used as spacers, however.

The invention also relates to a container covering, comprising a composite with a symmetrical structure that consists of polyester/aluminum/polyester, whereby preferably polyethylene terephthalate (PET) is used as a polyester.

The invention is explained in more detail below based on embodiments, comparative examples, as well as advantageous embodiments of the composite according to the invention.

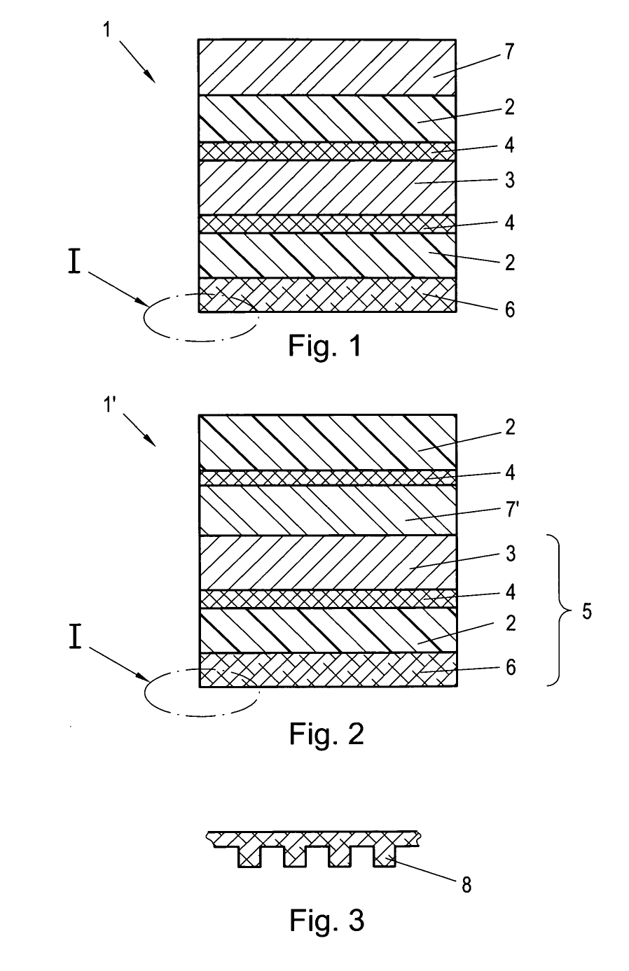

As an advantageous embodiment of the composite according to the invention, a container covering 1 with a symmetrical composite, comprising polyester/aluminum/polyester, is shown according to FIG. 1, whereby printing 7, in the form of first-form printing, is provided.

According to FIG. 2, an alternative embodiment 1′ of the container covering according to the invention is shown, whereby the printing 7′ is applied by means of interleaving printing.

FIG. 3 shows a cutaway I of the heat-seal lacquer layer 6, which advantageously is present in the form of a rough-surface imprint, consisting of spacers 8.

The production of the container covering 1, 1′ according to the invention is carried out by means of lamination processes, whereby an adhesive based on polyurethane is advantageously used as laminating adhesive.

For the production of a container covering 1, as depicted in FIG. 1, a polyester film, preferably a polyethylene terephthalate film 2 with a layer thickness in a range of 10-30 μm, is used. This PET film 2 is applied on one side with the laminating adhesive 4 and connected to the aluminum foil 3 via this adhesive layer. The layer thickness of the aluminum foil is, for example, in a range of 6-25 μm. On the open side of the aluminum foil 3, another laminating adhesive layer 4 is applied, adjacent to which is another PET film 2 with a layer thickness in the range of 10-30 μm. A heat-seal lacquer 6 is applied to the open side of the PET film 2. A printed layer 7 is attached to the opposite side, as shown in FIG. 1, for which known printing processes, such as intaglio printing, flexographic printing, and digital printing, can be used.

The container covering 1′, as shown in FIG. 2, is produced in this respect as a composite 5, consisting of the aluminum foil 3, and the laminating adhesive 4, and the polyester film 2, preferably a PET film, is formed. The printed layer 7′ is applied with interleaving printing to the open side of the aluminum foil 3. In turn, a laminating adhesive 4 is applied to the open side of the printed layer 7′, and said adhesive is covered with another polyester film, preferably the PET film 2. To carry out the function of the container covering, the unprinted side is now provided with a heat-seal lacquer layer 6.

The heat-seal lacquer layer 6 can, as shown in FIG. 3, be designed in the form of rough-surface spacers 8. These rough-surface spacers 8 ensure that air is enclosed between the gaps so that unstacking of container coverings 1, 1′ that are usually stored in stacks is facilitated. For further facilitation of this unstacking process, the heat-seal lacquer is advantageously mixed with granular additives.

Another aid during unstacking consists in embossing both the heat-seal lacquer 6 and the printed side 7, whereby a needle embossing is preferred. Also, these projections that are produced by the embossing ensure that unstacking of the container coverings 1, 1′ that are usually stored in stacks is facilitated. Their appearance through the needling process is not impaired by the multi-layer, symmetrical structure of the container covering 1, 1′.

The container covering 1, 1′ according to the invention is now compared to a cup plate, known in the art, with the symmetrical aluminum/PET/aluminum structure. As can be seen from the following table, in each case the breaking strength (N/15 mm), the elongation (%), and the puncture resistance are tested under measuring conditions with a 9.5 mm mandrel and a 70 mm opening, and the test results are compared to one another.

| | 1 | 2 | 3 |
|---|---|---|---|
| Lengthwise Breaking Strength | 73.9 | 75.2 | 71.0 |
| Crosswise Breaking Strength | 97.7 | 104.7 | 71.5 |
| Lengthwise Elongation | 116.0 | 60.5 | 19.1 |
| Crosswise Elongation | 78.6 | 58.0 | 22.3 |
| Puncture Resistance | 109.2 | 100.6 | 56.0 |
| 9.5 mm Mandrel | | | |
| 70 mm Opening | | | |

| | | | | |
|---|---|---|---|---|
| Structure 1 | PET | 12/A1 | 15/PET | 12 (According to the invention) |
| Structure 2 | PET | 12/A1 | 25/PET | 12 (According to the invention) |
| Structure 3 | A1 | 15/PET | 12/Al | 15 (Prior art) |

It can be seen from the above-mentioned table that the container covering 1, 1′ according to the invention shows a very high puncture resistance and tearing resistance in comparison to known, symmetrical composite structures. The measured values with respect to crosswise breaking strength are evidence that buckling points that usually occur, so-called flex cracks, are avoided. In addition, caused by the use of the very stable polyethylene terephthalate film, the puncture resistance is significantly improved in comparison to known composite structures, such as Structure 3 with an outer aluminum foil.

The symmetrical composite structure according to the invention also makes possible an elevated corrosion resistance when aggressive package contents and acidic compounds or compounds that form acid gases are stored in the food containers. In this connection, processed cheese and sauce dips were tested as foods, whereby a batch was decanted into known food containers, covered with a common aluminum foil, and another, identical batch was covered with the container covering 1, 1′ according to the invention. After four weeks of storage, corrosion could be found on the aluminum covering; conversely, the container covering 1, 1′ according to the invention did not show any areas of corrosion.

In addition, it has been shown that the container covering 1, 1′ according to the invention is easily manageable for the consumer; the tendency to roll that is known in the art is stopped by the symmetrical structure of the composite, specifically when relatively small material thicknesses are used, a circumstance to which due regard often also has to be paid because of disposal.

In addition, the container covering according to the invention shows a very good tearing resistance, which during opening prevents sharp edges from being produced on the torn-off film pieces, and therefore the risk of injury is significantly minimized.

Since, according to customer requests, often stringent demands are made on the appearance of packaging material, such as container coverings, it is possible to meet this request with the container covering 1, 1′ according to the invention, since the outer polyester film, preferably a polyethylene terephthalate film, shows a glossy appearance even in the printed state. This optical effect is not impaired in the slightest even after needle embossing, especially since the plastic films that are used ensure sufficient elasticity being present during the embossing process.

A satisfactory appearance can also be achieved for the case of an interleaving printing, which process in addition shows the advantage that the intermediate layer that faces the package contents and that consists of aluminum, laminating adhesive, polyester and heat-seal lacquer completely prevents the penetration of printing inks in the packaging material. In contrast, the printing ink is covered by a polyester layer, so that the often sensitive imprinting is protected against damage.

In summary, it can be said that with the container covering 1, 1′ according to the invention, an easily manageable packaging solution that corresponds to customer requests was found. This effect is achieved in that a symmetrical composite structure, consisting of a polyester film, an aluminum foil, and a polyester film, is used. The use of polyethylene terephthalate (PET) is especially preferred in this composite structure. Since polyester and thus also polyethylene terephthalate (PET) show a stable bond strength in heat-seal lacquers, the container coverings according to the invention have the same sealing properties as the aluminum cup plates that are known in the art. Nevertheless, in comparison to the latter, acid-containing packaging material can also be stored, since the PET film shows sufficient stability, in particular compared to acids as well as acid gases.

1. Composite for packaging material, in particular for container coverings, characterized in that the composite consists of a symmetrical plastic/aluminum/plastic composite.

2. Composite according to claim 1, wherein as plastic, films that consist of polypropylene, polyethylene, polyamide, or polyester are used.

3. Composite according to claim 1, wherein the thickness of the aluminum foil is 6-100 μm.

4. Composite according to claim 1, wherein the thickness of the plastic layer is 5-50 μm.

5. Composite according claim 1, wherein the aluminum foil is connected to the plastic films by means of a laminating adhesive.

6. Composite according to claim 1, wherein the composite on the side that faces the package contents is provided with an at least partial heat-seal adhesive layer.

7. Composite according to claim 1, wherein the aluminum foil is provided with a full or partial printing on one or both sides.

8. Composite according to claim 1, wherein the composite is embossed to improve the individuality.

9. Composite according to claim 1, wherein spacers are applied at least on one side of the composite to improve the individuality.

10. Use of the composite according to claim 1 as pre-cut parts or stamping parts for container coverings.

11. Container covering, comprising a composite with a symmetrical structure that consists of polyester/aluminum/polyester.

12. Container covering according to claim 11, wherein the polyester film consists of polyethylene terephthalate.

13. Container covering according to claim 11, wherein the thickness of the polyester film is in a range of 3-100 μm, preferably 10-30 μm.

14. Container covering according to claim 11, wherein the aluminum foil has a thickness of 3-40 μm, preferably 6-25 μm.

15. Container covering according to claim 11, wherein the container covering on the side that faces away from the package contents has printing in the form of first-form printing.

16. Container covering according to claim 1, wherein the container covering on the side that faces away from the package contents has printing in the form of an interleaving printing.

17. Container covering according to claim 11, wherein the container covering on the side that faces the package contents has a heat-seal lacquer layer.

18. Container covering according to claim 17, wherein the heat-seal lacquer layer is surface-rough and has the form of geometrically arranged spacers.

19. Container covering according to claim 17, wherein the heat-seal lacquer layer contains granular additives.

20. Container covering according to claim 11, wherein the container covering is embossed on one or both sides.
